(19) United States
(12) Patent Application Publication
(10) Pub. No.: US 2022/0173612 A1
(43) Pub. Date: Jun. 2, 2022

(54) SYSTEM FOR SUPPLYING ENERGY TO ELECTRICALLY OPERATED MINING MACHINES

(71) Applicant: LIEBHERR-MINING EQUIPMENT COLMAR SAS, Colmar Cedex (FR)

(72) Inventors: Tariq KAREEMULLA, Colmar (FR); Volker GLINIORZ, Breisach am Rhein (DE); Burkhard RICHTHAMMER, Freiburg / Breisgau (DE)

(21) Appl. No.: 17/593,543

(22) PCT Filed: Mar. 17, 2020
(86) PCT No.: PCT/EP2020/057273

§ 371 Date: Sep. 20, 2021

(30) Foreign Application Priority Data
Mar. 20, 2019 (DE) 10 2019 107 180.1

(51) Int. Cl. H02J 15/00; H02J 3/28; H02J 3/38

(52) U.S. Cl. CPC H02J 15/008; H02J 3/28; H02J 3/381; F03D 9/19; H02J 2300/28; H02J 2300/40; H02J 2300/24

(57) ABSTRACT

A system for supplying energy to electrically operated mining machines, which system includes a hybrid power-generation arrangement for outputting electricity for the mining machines, a cable routing system for routing at least one power cable from the hybrid power-generation arrangement to the mining machines, and at least one energy source for supplying energy to the hybrid power-generation arrangement, wherein the hybrid power-generation arrangement has an electrochemical energy store, a fuel cell and an internal combustion engine generator.

### TECHNICAL FIELD

The present disclosure relates to a system for supplying energy to electrically operated mining machines. The mining machines are typically used in surface mining or in a mine.

### BACKGROUND AND SUMMARY

Electrically driven mining machines require large and constant amounts of energy to perform their work, exactly like their diesel-operated counterparts. The amount of energy required for a medium-sized electrically driven hydraulic excavator amounts to multiple tens of megawatt hours per day.

It is therefore clear that the use of fossil energy carriers for power generation results in a high fuel consumption and leaves a negative CO₂ balance. Even though many attempts have been made, no serious measures have been taken to date to considerably reduce the emissions in the mines that operate fleets of electrically driven mining machines.

Such mining machines are typically connected to non-renewable energy sources so that their ecological effects are negative due to the consumption of a large amount of fossil fuels.

The consumption of fossil fuels in the operation of mining machines should be reduced with the aid of the disclosure and thus a smaller dependence on fossil fuels should be achieved overall so that as a result better economic and ecological effects are present. A part of this disclosure is a hybrid power generator that represents a key role in the reduction of the emission problem of electrically driven mining machines.

It is accordingly the aim of the disclosure to arrive at a reduction of CO emissions, UHC (unburned hydrocarbons) emissions, NOₓ emissions, CO₂ emissions and PM (particulate matter) of electrically driven mining machines by the use of clean electrical energy and to arrive at the minimization of the dependence on fossil fuels, with this being achieved by a reduction of the “well to wheel” emissions.

The system in accordance with the disclosure for supplying energy to electrically operated mining machines includes a hybrid power generation arrangement for outputting power for the mining machines, a cable routing system for guiding at least one power cable from the hybrid power generation arrangement to the mining machines, and at least one energy source for the energetic supply of the hybrid power generation arrangement, with the hybrid power generation arrangement having an electrochemical energy store, a fuel cell, and an internal combustion engine generator.

The disclosure thus proposes an innovative system to drive electrically driven mining machines with a mixed energy source from a hybrid power generator—either as a backup or as a primary power source. An ecologically sustainable drive of electrically driven mining machines is thus achieved that are connected to the power supply via a cable routing system.

The proportion of power that is generated with the aid of fossil fuels can be reduced by the provision of the hybrid power generation arrangement having different options for delivering power to the mining machines. The energy from the energy store or from the fuel cell can thus be used for the operation of the mining machines and the internal combustion engine generator can only be made use of when the capacity of the other energy sources cannot meet the power requirement of the mining machines.

The hybrid power generation arrangement is here typically arranged in the proximity of or directly at the mine in which the mining machines perform their work. The arrangement is spaced apart from the mining machines, with the power required for the operation of the mining machines being forwarded to them via lines. The lines connected to the machines are here combined in a cable routing system so that the operation of the machines in the mine can take place without any special consideration of the current-carrying lines. The mix of the three different power generation units permits a drawing of power that can largely dispense with the operation of the internal combustion engine generator on a corresponding dimensioning of the power generation units.

The hybrid power generation arrangement can here be designed as mobile, or also as stationary, with the mobile design bringing about the advantage that the cable routing system starting from it to the mining machine has to be dimensioned as less large since the mining machines work in a specific working zone of the mine as a rule. A mobile hybrid power generation arrangement is therefore advantageous in that it does not have to cover the total area of the mine with the cable routing system.

In accordance with an optional modification of the disclosure, the energy source comprises an electricity plant and/or a connection to a power supply network, with the electricity plant and/or the connection to the power supply network being connected to the electrochemical energy store, a hydrogen generation unit for producing and storing hydrogen that is connected to the fuel cell, and a fuel reservoir for a fossil fuel or for a fuel on a hydrogen base that is connected to the internal combustion engine generator, with a tank for taking up hydrogen and/or oxygen, for example, connected to the hydrogen production unit.

The electricity plant may provide for power generation by means of photovoltaic systems, wind power, and/or nuclear power so that no fossil fuel is burned in this process. The power grid additionally or alternatively provided can also deliver power generated in the same manner. It is, however, also conceivable that the power gird uses a mix of said power types together with power from fossil fuels. To more easily achieve the aims of the disclosure, it is, however, of advantage if the power is generated by a separate power plant and use is only made of regenerative energies such as wind and sun.

Since the production of power with the aid of wind and sun depends on external factors such as the wind strength and also the solar irradiation, generated excess energy that cannot be transmitted to the mining machines can be stored in the energy store of the hybrid power generation arrangement and can be supplied to the machines at a later time. It is additionally possible to supply the excess energy to the hydrogen generation unit that generates molecular hydrogen (H₂) and pure oxygen (O₂) from water (H₂O) by using the supplied power, for example by electrolysis. The hydrogen can then be used to generate power as required in a fuel cell. It is also possible that the hydrogen generation unit does not generate hydrogen on the basis of electrolysis, but rather acquires H₂ from natural gas or from the methane (CH₄) contained therein by reformation. For this purpose, molecular hydrogen (H₂) together with carbon dioxide (CO₂) is acquired from the methane (CH₄) while admixing water (H₂O) and a subsequent carbon monoxide conversion.

Provision is made that a power delivery of the electricity plant and/or of the power supply network is conducted through the hybrid power generation arrangement so that power for the mining machines can also be drawn directly from the electricity plant and/or from the connection to the power supply network.

It is thus ensured that the mining machines are operable directly with power from the electricity plant and/or from the connection to the power supply network. The hybrid power generation arrangement is made use of when the required capacity of the mining machines cannot be provided by the electricity plant and/or the grid connection or when there are fluctuations in the power transmission due to the regenerative energy generation, for example in a period of calm or on a switching off of the photovoltaic systems. A suddenly required peak load can, however, naturally also have the result that the hybrid power generation arrangement generates power and provides it to the mining machines.

In accordance with a further development of the disclosure, the electrochemical energy store, the fuel cell, and the internal combustion engine generator are each provided with a converter to convert their respective power outputs to a common DC level, with each of the plurality of converters being for example either a power converter, a DC-DC converter, and/or an AD-DC converter.

So that the different types of generation of current can also be conducted over a common line, it is of advantage if they have the same voltage level. Provision is made for this purpose that the different voltage levels of the energy store and of the power generation by the fuel cell are adapted by DC converters. The AC current generated by the internal combustion engine generator requires a rectification so that a potential difference after the harmonization of the voltage levels can be transmitted with the aid of two lines.

Since the mining machines typically run with AC current, however, the DC current can be converted into an AC current prior to a feeding of the power to the cable routing system. This conversion can, however, also only take place on the respective mining machine itself and the conducting of a DC current is as a rule subject to less loss than the conducting of an AC current.

In this respect, provision can also be made that the respective converters are connected to one another via a DC current line that is connected to the cable routing system for the mining machines. The DC current line can here also be connected via a DC-AC converter to the cable routing system leading to the mining machines.

It is possible in accordance with the disclosure that the electricity plant and/or the connection to the power supply network is/are connected to the hydrogen generation unit and to the electrochemical energy store such as a battery, a capacitor, or an ultracapacitor.

In accordance with the disclosure, the electrically operated mining machines can be any kind of mining machines, such as hydraulic excavators, wheeled loaders, bulldozers, and/or off-highway trucks. In accordance with the disclosure, all these mining machines are supplied with power via a cable routing system and therefore do not have to make use of a possibly present drive based on fossil fuels to carry out their intended functions.

In accordance with a modification of the disclosure, the hybrid power generation arrangement is configured to serve as a backup for a power grid or for providing a peak power requirement for the electrically operated mining machines.

Provision can moreover be made that the system furthermore comprises a control unit that is adapted to cover a required energy requirement of the mining machines with power from the electrochemical energy store, the fuel cell, and the electricity plant/power grid with a minimization of a fuel consumption by the internal combustion engine generator.

For this purpose, for example, the required energy requirement is compared with the available energy amounts from the electrochemical energy store, the fuel cell, and the electricity plant/power grid and the internal combustion engine is only activated when it is required to cover the energy requirement.

In an embodiment, the system can be adapted to store excess energy generated by the fuel cell in the electrochemical energy store. If energy is generated by the fuel cell and is not required by the mining machines, it can be buffered in the energy store. Sufficient energy is then available for a subsequent load peak. In addition, the energy store can in this way not only be charged by the electricity plant or the grid connection, but additionally by the fuel cell.

Provision can be made in accordance with a further development that the hybrid power generation arrangement is mobile or stationary and/or outputs an output voltage in the range from 6-12 kV. An output voltage in this range is required for the work of the mining machines.

When the internal combustion engine generator is a gas engine, the fuel reservoir connected to the internal combustion engine generator can furthermore also supply the hydrogen generation unit with the fuel stored therein for the generation of hydrogen. As already explained above, hydrogen can also be produced from natural gas since a high quantity of methane is contained therein. It is thus of advantage to use the tank for a gas-operated internal combustion engine generator simultaneously as a tank for the hydrogen generation unit to save space and resources. It is clear to the skilled person that the hydrogen generation unit then generates hydrogen on the basis of a reformation.

Alternatively, when the internal combustion engine generator includes a hydrogen-assisted duel fuel diesel engine, an exhaust gas recirculation system and an exhaust aftertreatment system can be provided to reduce the emissions emitted.

It is of advantage here if the hydrogen generated by the hydrogen generation unit and stored is therefore not conducted to the fuel cell, but can rather also be tapped by the hydrogen-assisted dual fuel diesel engine.

In accordance with a further development of the disclosure, when the internal combustion engine generator requires H₂ or O₂, it can be supplied directly by a reservoir of the hydrogen generation unit, with the hydrogen generation unit then having an electrolysis unit for splitting H₂O in which both H₂ and O₂ are accumulated.

Provision can be made in accordance with a further development that, when the internal combustion engine generator is operated with hydrogen, it can be supplied directly from the hydrogen generator unit.

### BRIEF DESCRIPTION OF THE FIGURES

Further details and features of the disclosure can be seen from the following description of the Figures. There are shown:

FIG. 1: a block diagram of the total system in accordance with the disclosure;

FIG. 2: a more detailed representation of FIG. 1;

FIG. 3: a schematic representation of the different energy sources;

FIG. 4: a schematic representation of the hybrid power generation arrangement;

FIG. 5: a flowchart for the operation of the system in accordance with the disclosure; and

FIG. 6: a flowchart for the operation of the hybrid power generation arrangement.

### DETAILED DESCRIPTION

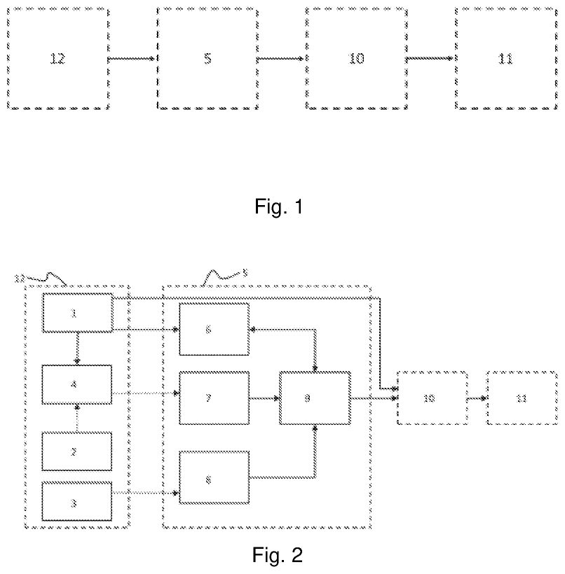

FIG. 1 shows the main basic components that are provided for the energy supply of the electrically driven mining machines 11 in accordance with the disclosure.

Starting from the at least one energy source 12, the hybrid power generation arrangement 5 is supplied. The power generated herein or the forwarded power is then passed on via the cable routing system 10 to the electrically driven mining machines 11 where the power is converted into mechanical work. As shown in detail later, the at least one energy source 12 can supply the electrically driven mining machines 11 with power both directly and via the hybrid power generation arrangement.

FIG. 2 shows the at least one energy source 12 and the hybrid power generation arrangement 5 in a representation richer in detail.

The at least one energy source 12 here includes an electricity plant and/or a connection to a power supply network 1, a hydrogen generation unit 4 for producing and storing hydrogen, and a fuel reservoir 3 for a fossil fuel or a fuel on a hydrogen basis.

The hybrid power generation arrangement 5 comprises an electrical control with a power converter 9 in addition to an electrochemical energy store 6, a fuel cell 7, and an internal combustion engine generator 8.

The energy store 6 is here charged with a power from the electrical plant and/or from the connection to a power supply network 1, as is symbolized by the continuous arrow. Provision can furthermore be made that the energy store 6 is charged by the fuel cell 7, with the power then being supplied to the energy store 6 via the power converter 9. The energy storage device 6 can, for example, be a heavy duty battery, typically on a lithium basis, or a capacitor, with either a lithium capacitor or an electrostatic double layer capacitor (EDLC) being able to be considered. The case is, however, also covered by the disclosure that a different kind of energy storage device having similar electrochemical properties is used. Provision can also be made in dependence on the application that the energy store 6 comprises an energy management system (EMS), more precisely a battery management system (BMS) or an ultracapacitor management system (UCMS) that controls the power supply to the energy store.

The fuel cell 7 is connected to the hydrogen generation unit 4 so that the components required for the operation of the fuel cell 7 is obtained via a fluid line (shown dashed). The fuel cell system 7 can, for example, consist of proton-exchange membrane fuel cells (PEMFCs) or solid oxide fuel cells (SOFCs) or other kinds of fuel cell stacks having comparable properties.

The internal combustion engine generator 8 likewise has a fluid line (shown dashed) via which a fossil fuel, typically diesel or natural gas, is supplied to the internal combustion engine.

The internal combustion engine generator 8 uses fuel from a fuel reservoir 3 for fossil fuels or is connected to the hydrogen generation unit 4.

When natural gas is stored in the reservoir 3, the internal combustion engine generator 8 is a gas engine generator. If in contrast the internal combustion engine generator 8 is hydrogen operated, the reservoir 3 is not required since hydrogen can be delivered directly by the hydrogen generation unit 4. The reservoir 3 is typically filled with diesel or gasoline so that the internal combustion engine generator 8 is a diesel engine generator or a gasoline engine generator.

Alternatively, a mixture of hydrogen and oxygen could be pumped from the hydrogen generation unit 4 into a diesel engine of the internal combustion engine generator 8 for a two-stage/assisted combustion. In combination with an exhaust gas recirculation system (AGR) and an exhaust aftertreatment system, this reduces the fuel consumption and reduces the total emissions (CO, CO₂, NON, HC) and the particulate emission in such a diesel engine generator 8.

Provision can furthermore be made that an output substance for the hydrogen generation unit 4 is stored in a tank 2. This tank 2 is shown with a fluidic line (dashed arrow) and supplies water or natural gas to the hydrogen generation unit 4.

If the tank 2 is to be filled with natural gas, the fuel reservoir 3 can be dispensed with since then the internal combustion engine generator 8 may also be operated with natural gas. A fluidic connection naturally then has to be present from the tank 2 for the supply of natural gas to the internal combustion engine generator 8.

It can additionally be recognized that the cable routing system 10 also forwards a current to the mining machines directly from the electricity plant and/or from the connection to a power supply network 1. The hybrid power generation arrangement 5 can thus only be operated at peak load or as a fall-back system to a conventional power supply. In some embodiments, it may occur that the power grid cannot provide the required powers of the mining machines so that the provision of the hybrid power supply arrangement 5 is of advantage and makes continuous operation of the mining machines possible.

As can furthermore be seen from FIG. 2, the mining machines 11 draw the power via the cable routing system 10 that connects the hybrid power generation arrangement 5 to the mining machines 11.

The hybrid power generation system 5 that is marked by reference numeral 5 and that typically has an output voltage of approximately 6-12 KV comprises, in addition to the electrochemical storage device 6, the fuel cell 7, and the internal combustion engine generator 8 that can be operated with hydrogen or with conventional fossil fuel, an energy conversion or an electronic arrangement 9 for power management and for the electrical conversion of the power provided by the different units.

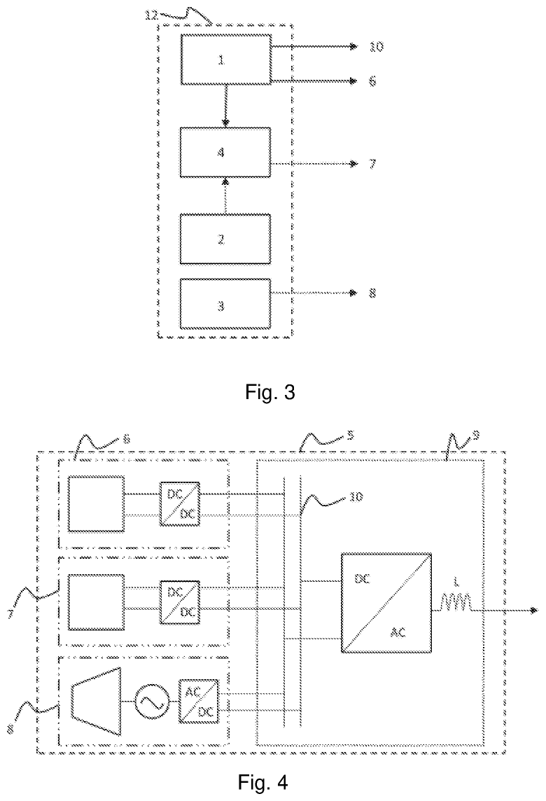

FIG. 3 shows an enlarged representation of the plurality of energy sources 12 and their connection points. It can be recognized that the electricity plant or the power connection 1 is directly connected to the cable routing system 10 and the energy store. The hydrogen generation unit 4 furthermore also obtains the power required for the reformation or for the electrolysis from the electricity plant or from the power connection 1.

The design and the properties of the hybrid power generation arrangement 5 depend on a plurality of parameters of the mine, inter alia on physical, chemical, and thermal restrictions that regulate the operation of its components. The operating behavior of the fuel cell 7 and of the energy store 6 can thus, for example, vary on the basis of the temperature profile of the mine.

In this respect, either the energy store 6 and/or the fuel cell 7 can serve as a back-up device in the arrangement 5. Under certain circumstances with a larger power requirement, the fossil fuel internal combustion engine generator 8 or the hydrogen based internal combustion engine generator 8 can be used as the main power device of the arrangement 5.

Although it is always desirable to have a small CO₂ emission, it is unavoidable in certain situations to use the internal combustion engine generator 8, for example when the energy requirement cannot simply be covered by the renewable energies, i.e. the energy store 6 and the fuel cell system 7.

FIG. 4 shows an enlarged representation of the hybrid power generation arrangement 5 from which it can be seen that the energy store 6 and the fuel cell 7 are each provided with a DC current converter that harmonizes the voltage levels to one another so that the generated power can be conducted to a common DC bus 10. The generator 8 has a rectifier that rectifies the AC current output by the generator and transforms it to the voltage level present on the DC bus 10.

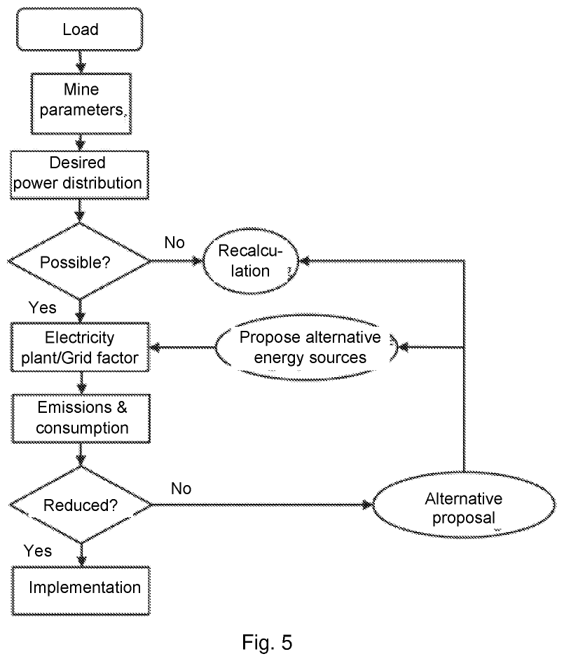

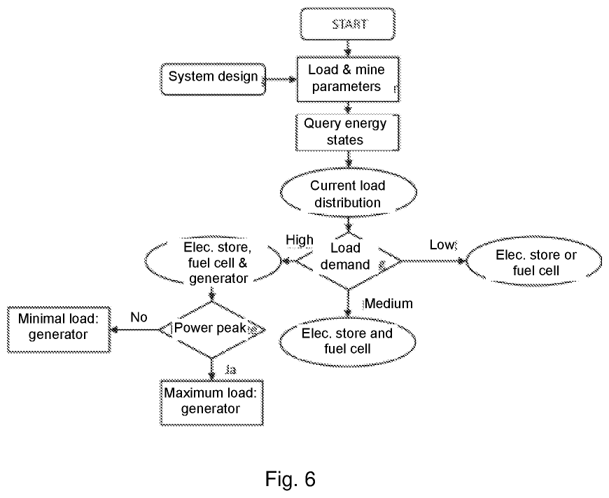

FIG. 5 shows an algorithm for the design of the hybrid power generator arrangement 5 that is based on parameters of the mine location. In accordance with this design, a regulation algorithm is integrated in the arrangement 5. In conjunction with the control logic shown in FIG. 6, the use of energy is provided such that the consumption of fossil fuels is lowered and in so doing the energy requirement is nevertheless simultaneously covered by electrically driven mining machines 11 in every operating phase.

Electrically driven mining machines 11 have a very dynamic load profile. The power from the electricity plant/grid 1 is used directly for the operation of such machines 11. When the power generated by the electricity plant or provided by the grid is mainly renewable such as by generation by sun or wind, the provision of power is subject to certain fluctuations. For example, the power generation fluctuates on a cloudy day or at night when the sunlight is reduced or not present so that there are losses in the power generation. There is a similar behavior at lower wind speeds.

As mentioned above, the energy store 6 can be used to store the excess energy that is delivered by the electrical plant/grid 1. The stored energy can then be used for a back-up operation. The additional energy requirement of electrically driven mining devices 11 can also be covered by the other components of the arrangement 5, namely by the fuel cell 7 and the internal combustion engine generator 8. In situations in which a peak power requirement of the electrically driven mining devices 11 is present and it cannot be covered solely by the electricity plant/grid 1, the hybrid power generation arrangement 5 is used to cover the additional power requirement. The control logic takes account of the time routine, the operating time, the different loads of the plurality of energy sources 12, and the arrangement 5 by the load profile of the electrically driven mining machines 11.

FIG. 5 shows an exemplary operating procedure of the hybrid power generation arrangement in dependence on some parameters at the mine side. Provision can be made in accordance with the disclosure that the routines described in FIG. 5 can be implemented by means of a control unit of the system in accordance with the disclosure.

In this respect, the load required by the mining machines that is required for the performance of the machine work is at the start.

In dependence on the mine parameters present such as the usual solar irradiation or wind strength to be expected over the day and/or the quota of power that can be obtained via the grid and that is based on renewable energies, a desired division of the different possibilities for the provision of power is fixed. It can thus be desirable in one case to set the contribution of the internal combustion engine generator at the required load to zero and only to use the fuel cell together with the power from the electricity plant/grid to cover the power requirement. It would, however, naturally also be conceivable to carry out any other desired division between the different elements to cover the energy requirement of the required load.

A check is then made in a next step whether the desired distribution can be implemented or not. If implementation should not be possible, the distribution is recalculated, with the failed implementation of the preceding desired distribution being taken into account in the recalculation.

If the desired distribution of the provision of the required power can be implemented with the aid of the system in accordance with the disclosure, the division of the power drawn from the two sources (electricity plant and grid connection is fixed—on the presence of an electricity plant in addition to a grid connection, with the different emission loads of the two sources being taken into account. It is clear to the skilled person that this is decisively influenced by the underlying type of power generation. It can, for example, be assumed that the electricity plant built in the near zone of the mine uses regenerative energy production, whereas the grid connection generates power from fossil fuels to a large extent.

The consumption of the fossil fuels and the CO₂ emissions produced in this process is subsequently calculated with a fixed division of the power quota from the electricity plant and the grid. This calculation can therefore determine the negative environmental effects of the selected division of the power volume between the electricity plant, the grid, the electrochemical energy store, the fuel cell, and the internal combustion engine generator.

If it is found in this process that the emissions and/or the consumption of fossil fuels are not smaller than before, an alternative power division between the different units is proposed that is based to a smaller extent on fossil energy sources. Provision can now be made for this purpose that the drawing of the required power should now no longer be covered solely or to a large extent by the grid or by the electricity plant, but rather increasingly also the further alternative energy sources of the hybrid power generation arrangement are considered, namely the electrochemical energy store, the fuel cell, and the internal combustion engine generator.

If in contrast the emissions and/or the consumption of fossil fuels is/are smaller than before, the intended division for the provision of the required power requirement is validated and implemented.

The ultimate aim of the above-described routine or algorithm is to reduce the total CO₂ footprint in that the dependence on non-renewable energy sources and fossil fuels is minimized.

FIG. 6 shows a control logic of the hybrid power generation arrangement based on parameters of the mine. The hybrid power generation is required when the grid or the electricity plant cannot serve the load requirement alone and/or only with unsatisfactory emission values.

Starting from a start of the logic that can also be embodied in a control unit of the system in accordance with the disclosure, the dynamic load distribution of the components for the power generation present in the arrangement is fixed while observing the structural design of the hybrid power generation arrangement, of the power demand (load), and of the mine-based parameters. The charge state of the energy store, the filling level of hydrogen, and the filling level of the fossil fuel is taken into account in this process.

The load distribution among the different units of the hybrid power generation arrangement is then fixed on the basis of the above-described information.

If the load demand is low, use is only made of the energy store or of the fuel cell.

In a middle range of the load demand, in contrast, the energy store and the fuel cell are operated.

The above ranges of the load demand are linked with no or with only very low damage to the environment at least in the H₂ generation by means of electrolysis by solar power and a power storage in the energy store performed therefrom.

On a high load demand, the generation of the required power is divided among all three of the components of the hybrid power generation arrangement so that some of the power generation is also taken over by the internal combustion engine generator that works with fossil fuels.

In this respect, the proportion of the power generation by the generator is minimized as a rule and the power generation is operated at full load by the generator only when a power peak is present, that is the requested power demand is unusually large.

The operation of the generator that is considered disadvantageous is thereby avoided as much as possible.

It is here the main aim to minimize the fuel consumption in the internal combustion engine generator on the basis of fossil fuels or hydrogen. The control logic should ensure an optimized operation to lower CO emissions, UHC (unburned hydrocarbons) emissions, NOₓ emissions, CO₂ emissions, and PC (particles).

1. A system for supplying energy to electrically operated mining machines comprising:
a hybrid power generation arrangement for outputting power for the mining machines;
a cable routing system for guiding at least one power cable from the hybrid power generation arrangement to the mining machines; and
at least one energy source for an energetic supply of the hybrid power generation arrangement, wherein
the hybrid power generation arrangement has an electrochemical energy store, a fuel cell, and an internal combustion engine generator.

2. The system in accordance with claim 1, wherein the at least one energy source comprises:
an electricity plant and/or a connection to a power supply network, wherein the electricity plant and/or the connection to the power supply network is/are connected to the electrochemical energy store;
a hydrogen generation unit for producing and storing hydrogen that is connected to the fuel cell; and
a fuel reservoir for a fossil fuel or a fuel on a hydrogen basis that is connected to the internal combustion engine generator.

3. The system in accordance with claim 2, wherein the electricity plant and/or the connection to the power supply network is connected to the hybrid power generation arrangement so that power for the mining machines is drawn directly from the electricity plant and/or from the connection to the power supply network.

4. The system in accordance with claim 1, wherein the electrochemical energy store, the fuel cell, and the internal combustion engine generator are each provided with a converter to convert their respective power outputs to a common DC level.

5. The system in accordance with claim 4, wherein the respective converters are connected to one another via a DC current line that is connected to the cable routing system for the mining machines.

6. The system in accordance with claim 2, wherein the electricity plant and/or the connection to the power supply network is/are connected to the hydrogen generation unit and to the electrochemical energy store, wherein the electrochemical energy store is a battery, a capacitor, or an ultracapacitor.

7. The system in accordance with claim 1, wherein the electrically operated mining machines are hydraulic excavators, wheeled loaders, bulldozers, and/or off highway trucks.

8. The system in accordance with claim 1, wherein the hybrid power generation arrangement is configured to serve as a backup for a power grid or for providing a peak power requirement for the electrically operated mining machines.

9. The system in accordance with claim 1, further comprising a control unit that is adapted to cover a required energy requirement of the mining machines with power from the electrochemical energy store, the fuel cell, and an electricity plant/power supply system.

10. The system in accordance with claim 1, wherein the system is adapted to store excess energy generated by the fuel cell in the electrochemical energy store.

11. The system in accordance with claim 1, wherein the hybrid power generation arrangement is mobile or stationary and outputs an output voltage in the range from 6-12 kV.

12. The system in accordance with claim 2, wherein, when the internal combustion engine generator is a gas engine, the fuel reservoir connected to the internal combustion engine generator can furthermore supply the hydrogen generation unit with the fuel stored therein for generation of hydrogen.

13. The system in accordance with claim 1, wherein, when the internal combustion engine generator comprises a hydrogen-assisted duel fuel diesel engine, an exhaust gas recirculation (EGR) system and an exhaust aftertreatment system can be provided to reduce emissions emitted.

14. The system in accordance with claim 2, wherein, when the internal combustion engine generator requires H₂, it is supplied directly by the fuel reservoir for a fuel based on hydrogen, with the hydrogen generation unit having an electrolysis unit for splitting H₂O.

15. The system in accordance with claim 2, wherein, when the internal combustion engine generator is operated with hydrogen, it is supplied directly from the hydrogen generation unit.

16. The method according to claim 2, wherein a tank for taking up hydrogen is connected to the hydrogen generation unit.

17. The method according to claim 4, wherein each of the converters is either a power converter, a DC-DC converter, and/or an AD-DC converter.

18. The method according to claim 5, wherein the DC current line is connected to the cable routing system leading to the mining machines via a DC-AC converter.

19. The method according to claim 15, wherein the hydrogen generation unit includes a steam reformer that converts methane or natural gas into hydrogen and carbon oxides.
